(19) United States
(12) Patent Application Publication
(10) Pub. No.: US 2020/0201566 A1
(43) Pub. Date: Jun. 25, 2020

(54) MODULE PROCESSING RESOURCE

(71) Applicant: Micron Technology, Inc., Boise, ID (US)

(72) Inventor: Robert M. Walker, Raleigh, NC (US)

(21) Appl. No.: 16/226,119

(22) Filed: Dec. 19, 2018

(51) Int. Cl. G06F 3/06

(52) U.S. Cl. CPC G06F 3/0659; G06F 3/0683; G06F 3/0604

(57) ABSTRACT

The present disclosure includes apparatuses and methods related to a module processing resource. An example apparatus can include a first interface coupled to a host, and a second interface coupled to a memory module. The apparatus may be configured to process data between the host and the memory module via a processing resource.

### TECHNICAL FIELD

The present disclosure relates generally to memory devices, and more particularly, to apparatuses and methods for a module processing resource.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

Memory can be part of a memory module (e.g., a dual in-line memory module (DIMM)) used in computing devices. Memory modules can include volatile, such as DRAM, for example, and/or non-volatile memory, such as Flash memory or RRAM, for example. The DIMMs can be using a main memory in computing systems.

### BRIEF DESCRIPTION OF THE DRAWINGS

FIG. 1 is a block diagram of an apparatus in the form of a computing system including a memory system in accordance with a number of embodiments of the present disclosure.

FIGS. 2A and 2B is a block diagram of an apparatus in the form of a computing system including at least a portion of a memory system on a printed circuit board (PCB) in accordance with a number of embodiments of the present disclosure.

FIG. 3 is a block diagram of an apparatus in the form of a computing system including a memory system having a module with a processing resource and a memory module with a memory system controller in accordance with a number of embodiments of the present disclosure.

FIG. 4 is a block diagram of an apparatus in the form of a computing system including a memory system having a memory module with a memory system controller and a module with a processing resource in accordance with a number of embodiments of the present disclosure.

FIG. 5 is a block diagram of an apparatus in the form of a computing system including a memory system having a memory module with a memory system controller and a processing resource in accordance with a number of embodiments of the present disclosure.

FIG. 6 is a flow diagram illustrating an example method of using a processing resource on a module in accordance with a number of embodiments of the present disclosure.

### DETAILED DESCRIPTION

The present disclosure includes apparatuses and methods related to a module processing resource. An example apparatus can include a first interface coupled to a host, and a second interface coupled to a memory module, wherein the apparatus is configured to process data between the host and the memory module via a processing resource.

In a number of embodiments, a first module can be coupled to a host via a first interface. The first interface can be formed on a printed circuitry board. The first module can be coupled to a number of other modules via a second interface. The host can communicate to the number of other modules through the first DIMM via the first interface. The first module can include processing resource to process data received from the host and/or the other modules. The number of other modules can include a processing resource to process data received from the host, the first module and/or the number of other modules.

In the following detailed description of the present disclosure, reference is made to the accompanying drawings that form a part hereof, and in which is shown by way of illustration how a number of embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure. As used herein, the designator “N” indicates that a number of the particular feature so designated can be included with a number of embodiments of the present disclosure.

As used herein, “a number of” something can refer to one or more of such things. For example, a number of memory devices can refer to one or more of memory devices. Additionally, designators such as “N”, as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

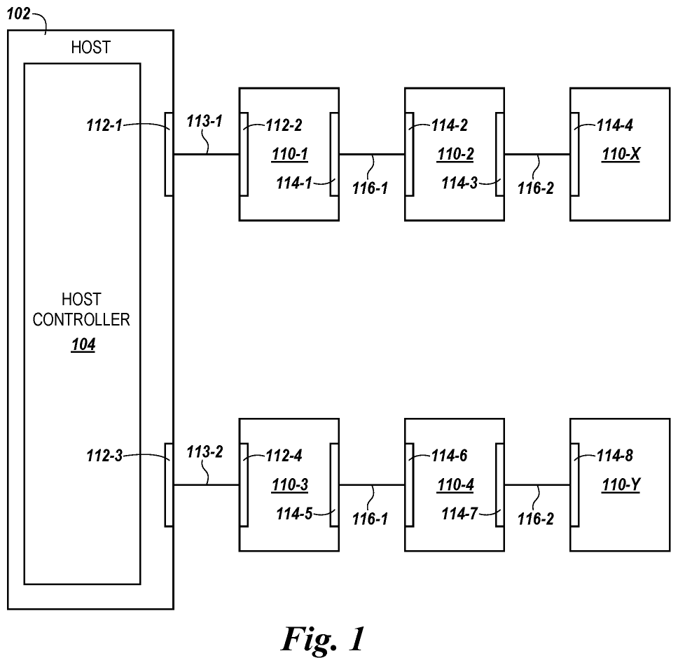

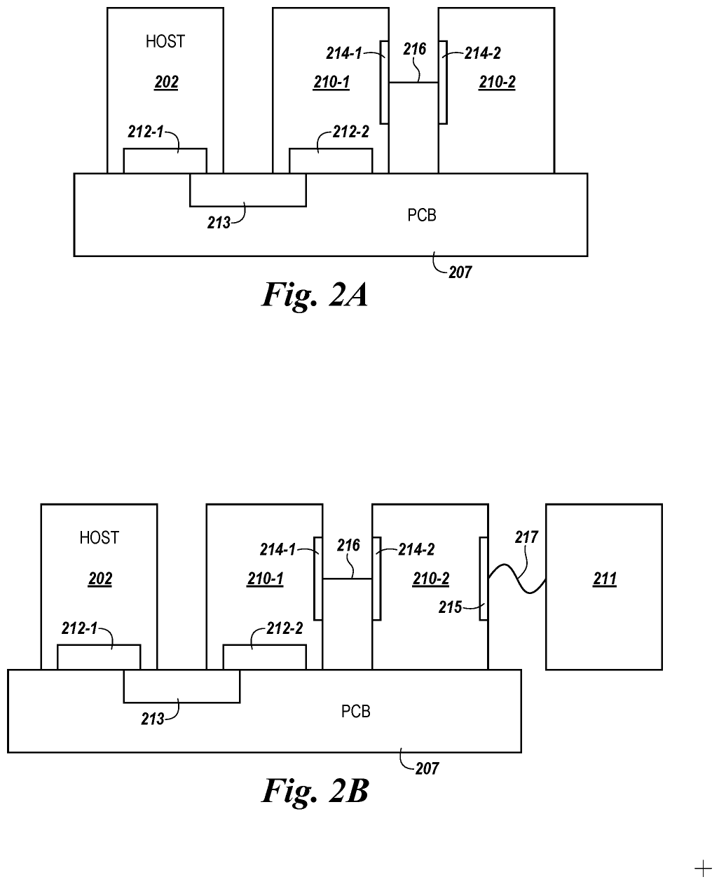

FIG. 1 is a block diagram of an apparatus in the form of a computing system including a memory system in accordance with a number of embodiments of the present disclosure. As used herein, an “apparatus” can refer to, but is not limited to, any of a variety of structures or combinations of structures, such as a circuit or circuitry, a die or dice, a module or modules, a device or devices, or a system or systems, for example. In the embodiment illustrated in FIG. 1, a memory system can include one or more modules, such as modules 110-1, . . . , 110-X, 110-Y, for example. Modules 110-1, . . . , 110-X, 110-Y can be dual in-line memory modules (DIMM) and can include volatile memory, such as DRAM, and/or non-volatile memory, such as storage class memory and/or 3D X-point memory, among other types of memory. Modules 110-1, . . . , 110-X, 110-Y can be a module that include a processing resource and can be co-processors in a memory system. A processing resource can be a central processing unit (CPU), graphics processing unit (GPU), and/or a general purpose GPU (GPGPU), among other types of processing resources. Memory systems can include any type of memory device, such as DIMMs with memory. In a number of embodiments, a memory system can include a multi-chip device. A multi-chip device can include a number of different memory types and/or modules. For example, a memory system can include non-volatile or volatile memory and/or a processing resource on any type of a module. The examples described below in association with FIGS. 1-2 use a DIMM as the module, but the present disclosure can include modules (e.g., modules 110 and 210) with a processing resource and the protocol of the present disclosure can be used on any memory system.

In FIG. 1, a memory system includes host 102 coupled to DIMM 110-1 via a channel including bus 113-1, interface A 112-1, and interface A 112-1. DIMM 110-1 is coupled to DIMM 110-2 and 110-X and DIMM 110-1 can be coupled to additional DIMMs or other memory modules and/or devices that are not shown in FIG. 1. DIMMs 110-1, 110-2, and 110-X are coupled together and are configured to transfer commands and/or data between each other. In FIG. 1, DIMM 110-1 is coupled to DIMM 110-2 via bus 116-1, interface B 114-1, and interface B 114-2. DIMM 110-2 is coupled to DIMM 110-X via bus 116-2, interface B 114-3 and interface B 114-4. Interfaces A 112-1, 112-2, 112-3, and 112-4 can be used to couple host 102 to a DIMM (e.g., DIMMs 110-1 and 110-3 in FIG. 1). Interfaces B 114-1, . . . , 114-8 can be used to coupled DIMMs 110-1, . . . , 110-X, 110-Y to each other. Interface A can be a same type of interface as interface B; and interface A can be a different type of interface as Interface B. Interface A can be an NVDIMM interface that allows for non-deterministic execution of the commands. Interface B can be a parallel, a serial, and/or a multiple serial interface, for example. The type of interface for interface A and/or interface B can be dependent on the type of memory module and/or the type of memory devices on the memory module. For example, DIMM 110-1 can include interface A 112-2 that is an NVDIMM interface to communicate with host 102, where host 102 includes interface A 112-1 that is also in an NVDIMM interface. DIMM 110-1 can include interface B 114-1 that is an DDR5 interface to communicate with DIMM 110-2, where DIMM 110-2 is a DDR DIMM and includes interface B 114-2 that is a DDR5 interface. DIMM 110-2 can include interface B 114-3 that is a storage class memory interface to communicate with DIMM 110-X, where DIMM 110-X is a DIMM that includes storage class memory and interface B 114-4 is a storage class memory interface.

DIMMs 110-1 and 110-2 can be configured to received commands from host 102 via interface A 112-2 and interface A 112-4, respectively. DIMMs 110-1 and 110-2 can be configured to execute the commands by transferring data between DIMMs 110-1, . . . , 110-X, 110-Y via interfaces B 114-1, . . . , 114-8 and between host 102 and DIMMs 110-1 and 110-2 via interface A 112-2 and interface A 112-4, respectively. The DIMMs can be configured to transfer data between DIMMs 110-1, . . . , 110-X, 110-Y via interfaces B 114-1, . . . , 114-8 while transferring data between host 102 and DIMMs 110-1 and 110-2 via interface A 112-2 and interface A 112-4, respectively.

In FIG. 1, a memory system includes host 102 coupled to DIMM 110-3 via a channel including bus 113-2, interface A 112-3, and interface A 112-4. DIMM 110-3 is coupled to DIMM 110-4 and 110-Y and DIMM 110-1 can be coupled to additional DIMMs or other memory modules and/or devices that are not shown in FIG. 1. DIMMs 110-3, 110-4, and 110-Y are coupled together and are configured to transfer commands and/or data between each other. In FIG. 1, DIMM 110-3 is coupled to DIMM 110-4 via bus 116-3, interface B 114-5, and interface B 114-6. DIMM 110-4 is coupled to DIMM 110-Y via bus 116-4, interface B 114-7 and interface B 114-8.

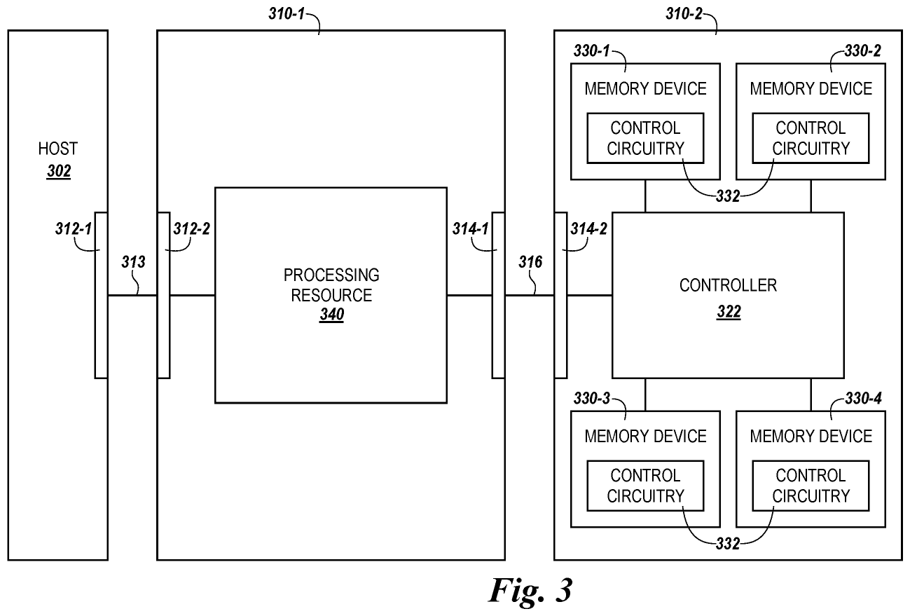

In a number of embodiments each of DIMMs 110-1, . . . , 110-X, 110-Y can include a controller, such as a memory system controller. In a number of embodiments, at least one of the DIMMs 110-1, . . . , 110-X that are coupled together can include a controller, such as a memory system controller; and at least one of the DIMMs 110-3, . . . , 110-Y that are coupled together can include a controller, such as a memory system controller. A memory system controller will be described below in association with FIGS. 3A-5. A controller on DIMMs 110-1, . . . , 110-X, 110-Y can receive commands from host 102 and control execution of the commands on a DIMM. Also, in a number of embodiments, the protocol of the present disclosure could be implemented by a memory device on a DIMM (e.g., a DIMM) without a controller and execution of the commands using the protocol of the present disclosure could be built into the memory device.

The host 102 can send commands to the DIMMs 110-1, . . . , 110-X, 110-Y using the protocol that is dependent on the type of memory in the DIMMs. For example, the host can use communication protocols such as an NVDIMM protocol to communicate on the same channel with an NVDIMM DIMM and a DDR5 protocol to communicate with a DRAM DIMM that are coupled together.

As illustrated in FIG. 1, a host 102 can be coupled to DIMMs 110-1, . . . , 110-X, 110-Y. In a number of embodiments, DIMMs 110-1, . . . , 110-X, can be coupled to host 102 via a channel that includes interface A 112-1 and 112-2, bus 113-1, interface B 114-1, . . . , 114-4, and bus 116-1 and 116-2. DIMMs 110-3, . . . , 110-Y, can be coupled to host 102 via a channel that includes interface A 112-3 and 112-4, bus 113-2, interface B 114-5, . . . , 114-8, and bus 116-3 and 116-4. Host 102 can be a laptop computer, personal computers, digital camera, digital recording and playback device, mobile telephone, PDA, memory card reader, interface hub, among other host systems, and can include a memory access device, e.g., a processor. One of ordinary skill in the art will appreciate that “a processor” can intend one or more processors, such as a parallel processing system, a number of coprocessors, a processing resource, etc.

Host 102 includes a host controller 104 to communicate with a memory system. The host controller 104 can send commands to the DIMMs 110-1, . . . , 110-X, 110-Y. The host controller 104 can communicate with the DIMMs 110-1, . . . , 110-X, 110-Y and/or a controller on each of the DIMMs 110-1, . . . , 110-X, 110-Y to read, write, and erase data, among other operations. An interface (e.g., interface A 112) can provide an interface for passing control, address, data, and other signals between a DIMM (e.g., DIMMs 110-1, . . . , 110-X, 110-Y) and host 102 having compatible receptors for the interface. The signals can be communicated between host 102 and DIMMs 110-1, . . . , 110-X, 110-Y on a number of buses (e.g., bus 113-1 and 113-2), such as a data bus and/or an address bus, for example, via a number of channels. An interface (e.g., interface B 114) can provide an interface for passing control, address, data, and other signals between DIMMs (e.g., DIMMs 110-1, . . . , 110-X, 110-Y) having compatible receptors for the interface. The signals can be communicated between DIMMs 110-1, . . . , 110-X, 110-Y on a number of buses (e.g., bus 116-1, . . . , 116-4), such as a data bus and/or an address bus, for example, via a number of channels.

The host controller 104 and/or a controller on a DIMM can include control circuitry, e.g., hardware, firmware, and/or software. In one or more embodiments, the host controller 108 and/or a controller on a DIMM can be an application specific integrated circuit (ASIC) coupled to a printed circuit board including a physical interface. Also, each DIMM 110-1, . . . , 110-X, 110-Y can include buffers of volatile and/or non-volatile memory and registers. Buffers can be used to buffer data that is used during execution of read commands and/or write commands. Registers can include commands to process data with a processing resource.

The DIMMs 110-1, . . . , 110-X, 110-Y can provide main memory for the memory system or could be used as additional memory or storage throughout the memory system. Each DIMM 110-1, . . . , 110-X, 110-Y can include a number of memory devices each having one or more arrays of memory cells, (e.g., volatile and/or non-volatile memory cells). The arrays can be flash arrays with a NAND architecture, for example. Embodiments are not limited to a particular type of memory device. For instance, the memory device can include RAM, ROM, DRAM, SDRAM, PCRAM, RRAM, 3D X-Point, and flash memory, among others.

The embodiment of FIG. 1 can include additional circuitry that is not illustrated so as not to obscure embodiments of the present disclosure. For example, the memory system can include address circuitry to latch address signals provided over I/O connections through I/O circuitry. Address signals can be received and decoded by a row decoder and a column decoder to access the DIMMs 110-1, . . . , 110-X, 110-Y. It will be appreciated by those skilled in the art that the number of address input connections can depend on the density and architecture of the DIMMs 110-1, . . . , 110-X, 110-Y.

FIGS. 2A and 2B is a block diagram of an apparatus in the form of a computing system including at least a portion of a memory system on a printed circuit board (PCB) in accordance with a number of embodiments of the present disclosure. In FIG. 2A, host 202, DIMM 210-1, and DIMM 210-2 are formed on PCB 207. Host 202 is coupled to DIMM 210-1 via interface A 212-1, interface A 212-2, and bus 213. Bus 213 is formed in PCB 207. Host 202 can send commands and/or data to DIMM 210-1 and DIMM 210-2 on bus 213. DIMM 210-1 is coupled to DIMM 210-2 via interface B 214-1, interface B 214-2, and bus 216. Commands and/or data from host 202, DIMM 210-1, and/or DIMM 210-2 can be transferred between DIMM 210-1 and 210-2 via interface B 214-1, interface B 214-2, and bus 216.

DIMM 210-1 and 210-2 can receive power and ground signals via connection points on the PCB 207. DIMM 210-2 can received commands and/or data on bus 216, which is off PCB 207. A number of DIMMs can be coupled together via buses (e.g., bus 216) and interfaces (e.g., interface B 214) that are not on the PCB 207. This allows a number of DIMMs to be coupled together and not be constrained by the physical limitations of using connections points on PCB 207. In a number of embodiments, bus 216 that couples DIMM 210-1 to DIMM 210-2 can be located on PCB 207.

Commands and/or data can be transferred between host 202 and DIMM 210-1 on bus 213 while commands and/or data is transferred between DIMM 210-1 and DIMM 210-2 on bus 216. Bus 213 and bus 216 can be controlled independently of each other. Also, DIMM 210-1 can be configured to transfer commands and/or data from host 202 that are intended for DIMM 210-2 to DIMM 210-2 and DIMM 210-1 can be configured to transfer commands and/or data from DIMM 210-2 that are intended for host 202 to host 202.

In FIG. 2B, host 202, DIMM 210-1, and DIMM 210-2 are formed on PCB 207 and solid state drive (SSD) 211 is coupled to DIMM 210-2. SSD 211 is not formed on PCB 207. Host 202 is coupled to DIMM 210-1 via interface A 212-1, interface A 212-2, and bus 213. Bus 213 is formed in PCB 207. Host 202 can send commands and/or data to DIMM 210-1 and DIMM 210-2 on bus 213. DIMM 210-1 is coupled to DIMM 210-2 via interface B 214-1, interface B 214-2, and bus 216. SSD 211 is coupled to DIMM 210-2 via interface C 215 and bus 217. Commands and/or data from host 202, DIMM 210-1, DIMM 210-2, and/or SSD 211 can be transferred between DIMM 210-1 and 210-2 via interface B 214-1, interface B 214-2, and bus 216 and/or between DIMM 210-1 and SSD 211 via interface C 215 and bus 217.

DIMM 210-1 and 210-2 can receive power and ground signals via connection points on the PCB 207. DIMM 210-2 can received commands and/or data on bus 216, which is off PCB 207. A number of DIMMs can be coupled together via buses (e.g., bus 216) and interfaces (e.g., interface B 214) that are not on the PCB 207. DIMMS can be coupled to other memory devices (e.g., SSD 211) that are also not on PCB 207. This allows a number of DIMMs and memory devices to be coupled together and not be constrained by the physical limitations of using connections points on PCB 207. In a number of embodiments, bus 217 and SSD 211 can be located on PCB 207.

FIG. 3 is a block diagram of an apparatus in the form of a computing system including a memory system having a module with a processing resource and a memory module with a memory system controller in accordance with a number of embodiments of the present disclosure. In FIG. 3, host 302 is coupled to module via interface A 312-1, interface A 312-2, and bus 313. Module 310-1 includes processing resource 340 coupled to interface A 312-2.

Module 310-1 is coupled to DIMM 310-2 via interface B 314-1, interface B 314-2, and bus 316. DIMM 310-2 includes controller 322 coupled to interface B 314-2. DIMM 310-2 includes memory devices 330-1, . . . , 330-4 coupled to controller 322. Memory devices 330-1, . . . , 330-4 can include non-volatile memory arrays and/or volatile memory arrays. Memory devices 330-1, . . . , 330-4 can include control circuitry 332 (e.g., hardware, firmware, and/or software) which can be used to execute commands on the memory devices 330-1, . . . , 330-4. Control circuitry 332 can receive commands from controller 322. Control circuitry 332 can be configured to execute commands to read and/or write data in the memory devices 330-1, . . . , 330-4. For example, memory devices 330-1, . . . , 330-4 can include storage class memory.

Processing resource 340 on module 310-1 can receive commands and/or data and process the data by rearranging and/or reordering the data and/or filtering the data, among other processing operations. Processing resource 340 can receive commands and/or data from host 302 and/or DIMM 310-2 and process the data before sending the processed data to host 302 and/or DIMM 310-2. For example, DIMM 310-1 can receive data from host 302 and read data from DIMM 310-2 and process the data by combining the data and/or performing operations on the data and writing the processed data to DIMM 310-2 and/or sending the processed data to host 302.

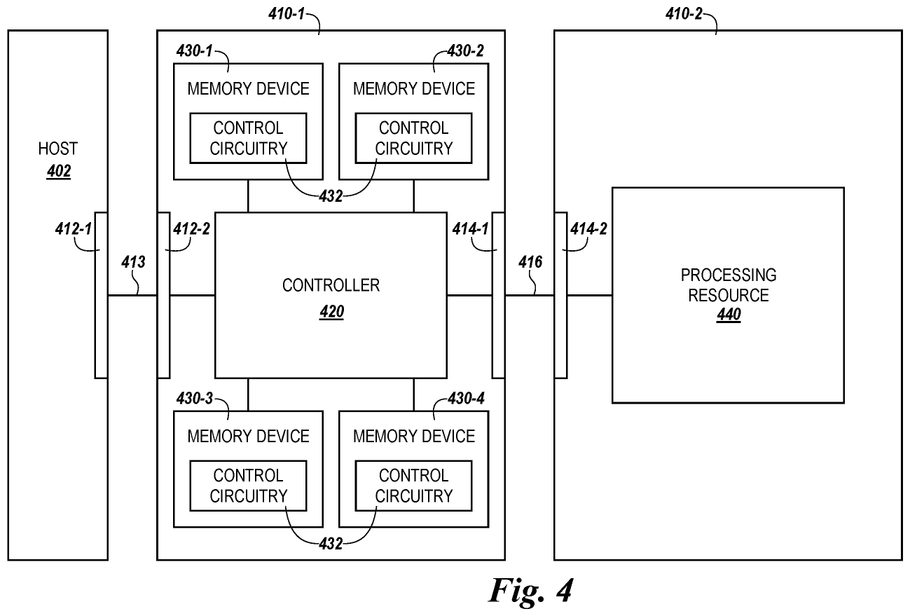

FIG. 4 is a block diagram of an apparatus in the form of a computing system including a memory system having a memory module with a memory system controller and a module with a processing resource in accordance with a number of embodiments of the present disclosure. In FIG. 4, host 402 is coupled to DIMM 410-1 via interface A 412-1, interface A 412-2, and bus 413. DIMM 410-1 includes controller 420 coupled to interface A 412-2. DIMM 410-1 includes memory devices 430-1, . . . , 430-4 coupled to controller 420. DIMM 410-1 can include registers on memory devices and/or controller 420 that can include commands to process data. Memory devices 430-1, . . . , 430-4 can include non-volatile memory arrays and/or volatile memory arrays. Memory devices 430-1, . . . , 430-4 can include control circuitry 432 (e.g., hardware, firmware, and/or software) which can be used to execute commands on the memory devices 430-1, . . . , 430-4. Control circuitry 432 can receive commands from controller 420. Control circuitry 432 can be configured to execute commands to read and/or write data in the memory devices 430-1, . . . , 430-4. For example, DIMM 410-1 can be an NVDIMM with memory devices 430-1 and 430-2 that include DRAM and memory devices 430-3 and 430-4 that include 3D X-Point memory.

DIMM 410-1 is coupled to module 410-2 via interface B 414-1, interface B 414-2, and bus 416. Module 410-2 includes processing resource 440 coupled to interface B 414-2. Module 410-2 can include registers that can include commands to process data. Processing resource 440 on module 410-2 can receive commands and/or data and process the data by rearranging and/or reordering the data and/or filtering the data, among other processing operations. Processing resource 440 can receive commands and/or data from host 402 and/or DIMM 410-1 and process the data before sending the processed data to host 402 and/or DIMM 410-1.

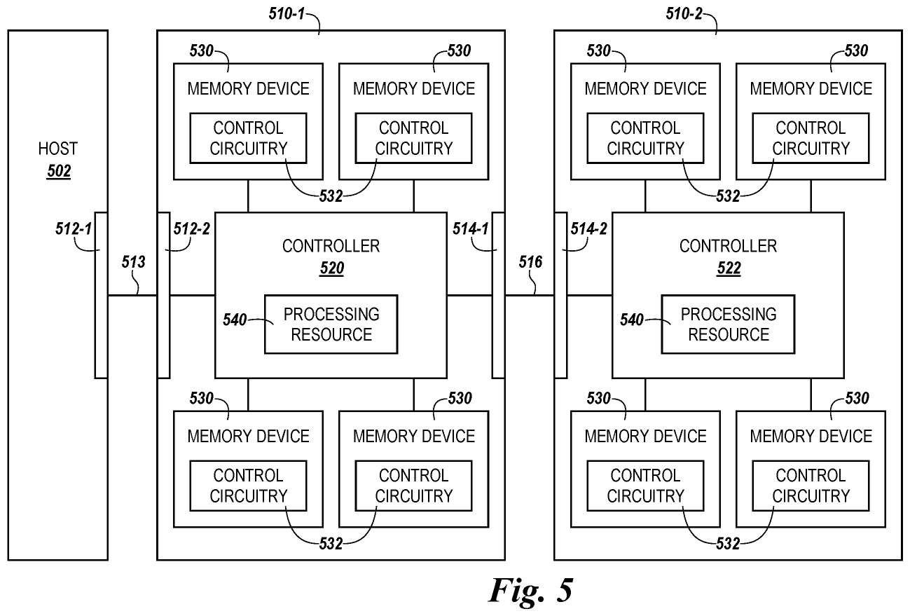

FIG. 5 is a block diagram of an apparatus in the form of a computing system including a memory system having a memory module with a memory system controller and a processing resource in accordance with a number of embodiments of the present disclosure. In FIG. 5, host 502 is coupled to DIMM 510-1 via interface A 512-1, interface A 512-2, and bus 513. DIMM 510-1 includes controller 520 coupled to interface A 512-2. DIMM 510-1 includes memory devices 530-1, . . . , 530-4 coupled to controller 520. Memory devices 530-1, . . . , 530-4 can include non-volatile memory arrays and/or volatile memory arrays. Memory devices 530-1, . . . , 530-4 can include control circuitry 532 (e.g., hardware, firmware, and/or software) which can be used to execute commands on the memory devices 530-1, . . . , 530-4. Control circuitry 532 can receive commands from controller 520. Control circuitry 532 can be configured to execute commands to read and/or write data in the memory devices 530-1, . . . , 530-4. For example, DIMM 510-1 can be DDR5 DIMM with memory devices 530-1, . . . , 530-4 that include DRAM. Controller 520 includes processing resource 540. Processing resource 540 on module 510-1 can receive commands and/or data and process the data by rearranging and/or reordering the data and/or filtering the data, among other processing operations. Processing resource 540 on controller 520 can receive commands and/or data from host 502, controller 520 on DIMM 510-1, and/or DIMM 510-2 and process the data before sending the processed data to host 502, memory devices 530-1, . . . , 530-4, and/or DIMM 510-2.

DIMM 510-1 is coupled to DIMM 510-2 via interface B 514-1, interface B 514-2, and bus 516. DIMM 510-1 includes controller 522 coupled to interface B 514-2. DIMM 510-2 includes memory devices 530-5, . . . , 530-8 coupled to controller 522. Memory devices 530-5, . . . , 530-8 can include non-volatile memory arrays and/or volatile memory arrays. Memory devices 530-5, . . . , 530-8 can include control circuitry 532 (e.g., hardware, firmware, and/or software) which can be used to execute commands on the memory devices 530-5, . . . , 530-8. Control circuitry 532 can receive commands from controller 520. Control circuitry 532 can be configured to execute commands to read and/or write data in the memory devices 530-5, . . . , 530-8. For example, memory devices 530-5, . . . , 530-8 can include storage class memory.

Controller 522 includes processing resource 540. Processing resource 540 on module 510-2 can receive commands and/or data and process the data by rearranging and/or reordering the data and/or filtering the data, among other processing operations. Processing resource 540 on controller 522 can receive commands and/or data from host 502, controller 525 on DIMM 510-2, and/or DIMM 510-1 and process the data before sending the processed data to host 502, memory devices 530-5, . . . , 530-8, and/or DIMM 510-1.

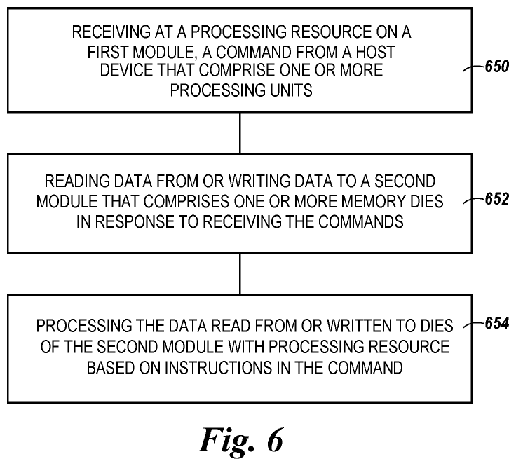

FIG. 6 is a flow diagram illustrating an example method of using a processing resource on a module in accordance with a number of embodiments of the present disclosure. The process described in FIG. 6 can be performed by, for example, a memory system including a module such as module 310 shown in FIG. 3.

At block 650, the method can include receiving, at a processing resource on a first module, a command from a host device that comprise one or more processing units. The command can also be generated by a register on a DIMM and or module.

At block 652, the method can include reading data from or writing data to a second module that comprises one or more memory dies in response to receiving the commands.

At block 654, the method can include processing the data read from or written to dies of the second module with the processing resource based on instructions in the command.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a processing resource configured to process data transferred between a memory module and a host that comprises at least one of a central processing unit (CPU), graphics processing unit (GPU), or a general purpose GPU (GPGPU), or any combination thereof
a first interface coupled to the processing resource and couplable to the host; and
a second interface coupled to the processing resource and couplable to the memory module.

2. The apparatus of claim 1, wherein the processing resource is configured to reorder data from the host for storage on the memory module.

3. The apparatus of claim 1, wherein the processing resource is configured to filter the data read from the memory module to the host.

4. The apparatus of claim 1, wherein the first interface is couplable to the host via a first bus and wherein the first bus is located on a PCB.

5. The apparatus of claim 1, wherein the second interface is couplable to the memory module via a second bus and wherein the second bus is located off a PCB.

6. The apparatus of claim 1, wherein the first interface is configured for a first communication protocol and the second interface is a configured for a second communication protocol that is different from the first communication protocol.

7. The apparatus of claim 6, wherein the first interface is configured for at least one of NVDIMM-P, NVDIMM-N, DDR5, or DDR4, or any combination thereof.

8. The apparatus of claim 6, wherein the second interface is configured to write data to or read data from a 3D XPoint array.

9. A system, comprising:
a first memory module with a first interface, a second interface, and a first processing resource;
a host including a third interface, wherein the host is coupled to the first memory module via the first interface, the third interface, and a first bus; and
a second memory module including a fourth interface, wherein the second memory module is coupled to the first memory module via the second interface, the fourth interface, and a second bus; and wherein the first processing resource is configured to process data for storage on the first memory module.

10. The system of claim 9, wherein the first processing resource is configured to process data for storage on the second memory module.

11. The system of claim 9, wherein the second memory module includes a second processing resource.

12. The system of claim 11, wherein the second processing resource is configured to process data for storage on the second memory module.

13. The system of claim 11, wherein the second processing resource is configured to process data for storage on the first memory module.

14. The system of claim 9, wherein the first processing resource is configured to process data by reordering the data and sending the reordered data to the second memory module via the second interface, the fourth interface, and the second bus.

15. The system of claim 9, wherein the first processing resource is configured to process data by reordering the data and sending the reordered data to the second memory module via the first interface, the third interface, and the first bus.

16. The system of claim 9, wherein the second processing resource is configured to process data by reordering the data and sending the reordered data to the first memory module via the second interface, the fourth interface, and the second bus.

17. A method, comprising:
receiving, at a processing resource on a first module, a command from a host device that comprise one or more processing units;
reading data from or writing data to a second module that comprises one or more memory dies in response to receiving the commands; and
processing the data read from or written to dies of the second module with the processing resource based on instructions in the command.

18. The method of claim 17, further including storing the processed data on the memory module that includes the processing resource.

19. The method of claim 17, wherein storing the processed data includes transferring the processed data from a module that includes the processing resource to the memory module.

20. The method of claim 17, wherein processing the data includes reordering the data and further including storing the reordered data on the memory module.

21. The method of claim 17, further including receiving the command from a host at a module that includes the processing resource.
